(19) United States
(12) Patent Application Publication
(10) Pub. No.: US 2018/0314479 A1
(43) Pub. Date: Nov. 1, 2018

(54) INFORMATION PROCESSING SYSTEM, METHOD FOR STORING JOB LOG, AND INFORMATION PROCESSING APPARATUS

(71) Applicant: Ryutaro SAKANASHI, Kanagawa (JP)

(72) Inventor: Ryutaro SAKANASHI, Kanagawa (JP)

(21) Appl. No.: 15/963,399

(22) Filed: Apr. 26, 2018

(30) Foreign Application Priority Data
Apr. 28, 2017 (JP) 2017-090673

(51) Int. Cl. G06F 3/12

(52) U.S. Cl. CPC G06F 3/1273; G06F 3/1235; G06F 3/1287

(57) ABSTRACT

An information processing system includes an apparatus installed with a web browser and one or more information processing apparatuses connected to the apparatus through a network. The one or more information processing apparatuses includes first circuitry and second circuitry. The first circuitry provides the apparatus with a content executable on the web browser. The content is embedded with an instruction to transmit a log of processing performed according to a user request. The second circuitry provides a device coordination service that coordinates the apparatus in which the content is executed with the web browser with a service to be provided through the network, and receives, from the apparatus in which the content is executed, a log of processing performed with the apparatus. The processing is performed according to a user request. The second circuitry also stores the log transmitted from the apparatus in a memory.

### CROSS-REFERENCE TO RELATED APPLICATIONS

This patent application is based on and claims priority pursuant to 35 U.S.C. § 119(a) to Japanese Patent Application No. 2017-090673, filed on Apr. 28, 2017, in the Japan Patent Office, the entire disclosure of which is hereby incorporated by reference herein.

### BACKGROUND

### Technical Field

The present disclosure relates to an information processing system, a method for storing a job log, and an information processing apparatus.

Discussion of the Background Art

A service is known, which coordinates an input and output device such as a multifunction peripheral (MFP) and a service provided on a cloud (hereinafter referred to as a device coordination service).

For example, in an information processing system, which provides a print service, a job log monitoring service, and an MFP, a log of jobs with image data of each job executed by the MFP is generated and stored in a server for monitoring.

### SUMMARY

An information processing system includes an apparatus installed with a web browser and one or more information processing apparatuses connected to the apparatus through a network. The one or more information processing apparatuses includes first circuitry and second circuitry. The first circuitry provides the apparatus with a content executable on the web browser. The content is embedded with an instruction to transmit a log of processing performed according to a user request. The second circuitry provides a device coordination service that coordinates the apparatus in which the content is executed with the web browser with a service to be provided through the network, and receives, from the apparatus in which the content is executed, a log of processing performed with the apparatus. The processing is performed according to a user request. The second circuitry also stores the log transmitted from the apparatus in a memory.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example configuration of an information processing system according to one of the embodiments;

FIG. 2 is a table illustrating examples of printing types, job printing and storage printing;

FIG. 3 is a block diagram illustrating a hardware configuration of a computer according to one of the embodiments;

FIG. 4 is a diagram illustrating a hardware configuration of a multifunction peripheral (MFP);

FIG. 5 is a block diagram illustrating a functional configuration of a control device according to one of the embodiments;

FIG. 6 is a block diagram illustrating a functional configuration of a job execution service apparatus according to one of the embodiments;

FIG. 7 is a block diagram illustrating another functional configuration of a job execution service apparatus according to one of the embodiments;

FIG. 8 is a sequence diagram illustrating a log acquisition process in the job printing, according to one of the embodiments;

FIG. 9 is an illustration of an example of update of print setting values;

FIG. 10 is an illustration of an example of screen transition in the log acquisition process in the job printing, according to one of the embodiments;

FIG. 11 is a sequence diagram illustrating a log acquisition process in the storage printing, according to one of the embodiments;

FIG. 12 is an illustration of an example of screen transition in the log acquisition process in the storage printing, according to one of the embodiments;

FIG. 13 is a table illustrating an example of a configuration of logs of print jobs stored in a log storage device;

FIG. 14 is a block diagram illustrating another functional configuration of a control device according to another one of the embodiments;

FIG. 15 is a block diagram illustrating a functional configuration of a job execution service apparatus according to another one of the embodiments;

FIG. 16 is a diagram illustrating a functional configuration of a job execution service apparatus in a case of the storage printing, according to another one of the embodiments;

FIG. 17 is a sequence diagram illustrating a log acquisition process in the job printing according to another one of the embodiments; and

FIG. 18 is a sequence diagram illustrating a log acquisition process in the storage printing, according to another one of the embodiments.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Hereinafter, a description is given of several embodiments of the present disclosure with reference drawings.

### First Embodiment

### <System Configuration>

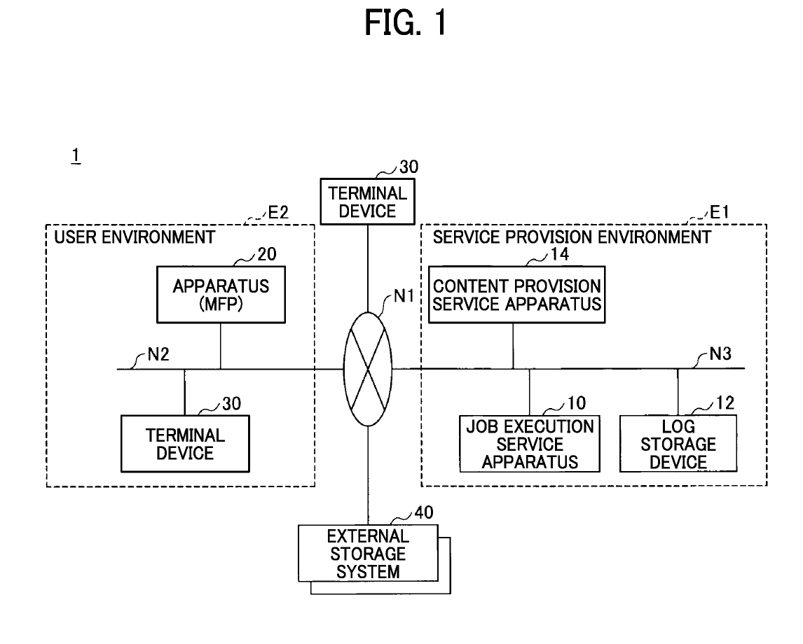

FIG. 1 is a schematic view illustrating an example configuration of an information processing system 1 according to a first embodiment. The information processing system 1 illustrated in FIG. 1 includes a service provision environment E1, a user environment E2, and an external storage system 40 each of which are communicably connected to each other through a wide area network N1 such as the Internet.

The service provision environment E1 is a system environment for providing a service such as a cloud service through the network N1 such as the Internet. In the following description, as one example of the services, the cloud service is used to describe the embodiment, however the embodiment is not limited to this, and as other examples of the services, a service provided by an application service provider (ASP) or a service related to the web may be used, for example.

In the service provision environment E1 of FIG. 1, a job execution service apparatus 10, a log storage device 12, and a content provision service apparatus 14 are connected to each other through a network N3 such as a local area network (LAN), for example.

The job execution service apparatus 10 is a service for executing a job in a cloud side. The job execution service apparatus 10 receives job execution from the user environment E 2 and intermediates with the external storage system 40. The log storage device 12 stores a log of jobs executed in the user environment E 2.

The content provision service apparatus 14 is a server computer to execute a service program for providing a content to the user. The content includes a web application running with a web browser. In the information processing system 1 according to the present embodiment, the content provided to the user environment E2 from the content provision service apparatus 14 has a mechanism of transmitting a log, which is described later.

The service provision system E1 is implemented with one or more information processing apparatuses. All or a part of the job execution service apparatus 10, the log storage device 12, and the content provision service apparatus 14 of the service provision environment E1 may be provided in the user environment E2. That is, the user environment E2 may include all or a part of one or more the information processing apparatuses configuring the service provision environment E1.

The user environment E2 is, for example, a system environment of an office or any other environment of a user (service user) who uses an apparatus 20 such as a multifunction peripheral (MFP). In the user environment E2, the apparatus 20 and a terminal device 30 are connected through a network N2, such as a LAN, for example.

The apparatus 20 is an example of an electronic apparatus to execute printing according to user operation. Examples of the apparatus 20 include an MFP and a printer. The apparatus 20 is installed with a web browser. The apparatus 20 executes the content provided from the content provision service apparatus 14 with the web browser. The user executes the printing using the content executing on the web browser.

The terminal device 30 is an operation terminal that is operated by the user and includes a personal client computer (PC), a smartphone, and a portable phone, each of which is installed with a general-purpose operating system (OS). The user inputs a print job to the service provision environment E1 using the terminal device 30. The user also stores a file to be used for printing in the external storage system 40 using the terminal device 30.

The external storage system 40 is a computer system that provides a cloud service called as a storage service (or an online storage) through the network N1. The storage service is a service that offers a storage area to, for example, the service provision environment. In one or more embodiments, the external storage system 40 is implemented with a plurality of information processing apparatuses.

The configuration of the information processing system 1 illustrated in FIG. 1 is one example. In one or more embodiments, there are the plurality of apparatuses 20 in the configuration of the information processing system 1, for example. Additionally, the terminal device 30 may be connected to the network N1. Additionally, a job to be exacted in the user environment E2 is not limited to a print job, or a job for printing.

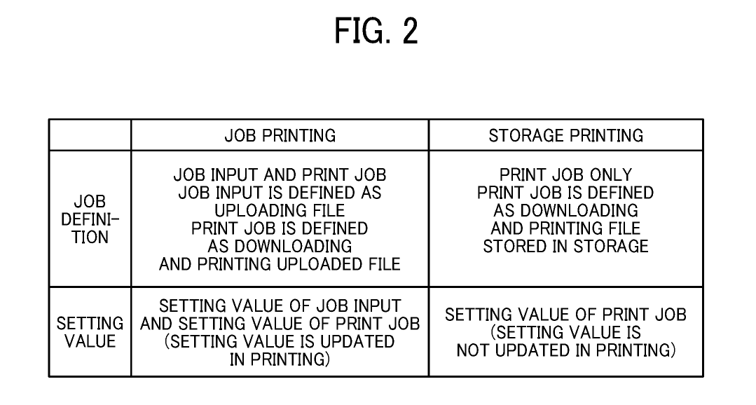

For example, in the information processing system 1 illustrated in FIG. 1, there are different types of printing, for example, job printing (pull printing) and storage printing. FIG. 2 is a table illustrating examples of the printing patterns, the job printing and the storage printing.

The job printing is mainly classified into a process of inputting a job (job input) and a process of printing the job (print job). The job input is a process of inputting a job from the terminal device 30 to a storage managed in the service provision environment E1. The print job is a process of downloading the job from the storage managed in the service provision environment E1 to the apparatus 20 and printing the downloaded job with the apparatus 20. As a setting value of the job printing, there are a setting value to be configured at a time of job input (setting value of job input) and a setting value to be configured at a time of print job (setting value of print job). The setting values of job input are updated to the setting values of print job.

The storage printing includes a process of printing a job (print job). More specifically, the print job of the storage printing includes a process of downloading a file form the external storage system 40 to the apparatus 20 and a process of printing the downloaded file with the apparatus 20. A setting value of the storage printing is a setting value to be configured at a time of printing (setting value of print job).

### <Hardware Configuration>

### Computer

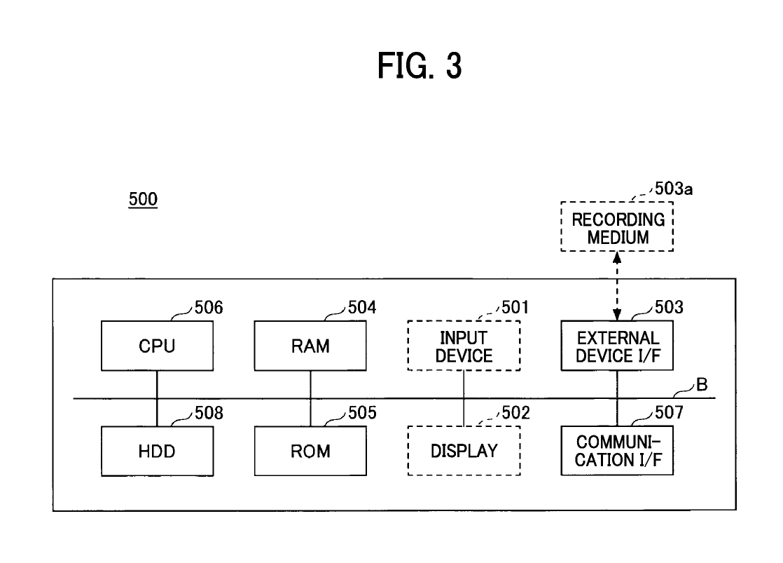

FIG. 3 is a block diagram illustrating a hardware configuration of a computer 500, and each of the one or more information processing apparatuses configuring each of the job execution service apparatus 10, the log storage device 12, and the content provision service apparatus 14 illustrated in FIG. 1 has substantially the same configuration as the hardware configuration illustrated in FIG. 3. Additionally, each of the one or more information processing apparatuses configuring the external storage system 40 has substantially the same hardware configuration as the hardware configuration illustrated in FIG. 3. The terminal device 30 illustrated in FIG. 1 has also substantially the same hardware configuration as that of the computer illustrated in FIG. 3.

FIG. 3 is a block diagram illustrating an example hardware configuration of the computer 500. As illustrated in FIG. 3, the computer 500 includes an input device 501, a display 502, an external device interface (I/F) 503, a random access memory (RAM) 504, a read only memory (ROM) 505, a central processing unit (CPU) 506, a communication interface (I/F) 507, and a hard disc drive (MD) 508, which are connected to one another through a bus B. It should be noted that the input device 501 and the display 502 are not necessarily constantly connected to the bus B, but are connected to the bus B when being used.

The input device 501 includes a keyboard, a mouse, and/or a touch panel enabling a user to input various operation signals. The display 502 displays results of processing performed by the computer 500. The display includes, for example, a liquid crystal display (LCD).

The communication interface 507 is an interface that connects the computer 500 to various networks. The computer 500 performs data communicates via the communication interface 507.

The HDD 508 is an example of a nonvolatile storage device that stores programs and/or data. Examples of the programs and/or data stored in the HDD 508 include an operating system (OS) for controlling an overall operation of the computer 500 and application software providing various functions on the OS. In one or more embodiments, the computer 500 includes, instead of or in addition to the HDD 508, a drive device such as a solid state drive (SSD) that uses a flash memory as a storage medium.

The external device interface 503 is an interface device with an external device. Examples of the external device include a recording medium 503a. The external device interface 503 enables the computer 500 to read and write data from and to the recording medium 503a. Examples of the recording medium 503a include a flexible disc, a compact disc (CD), a digital versatile disc (DVD), a secure digital (SD) memory card, and a universal serial bus (USB) memory.

The ROM 505 is an example of a nonvolatile semiconductor memory (storage device), which holds programs and/or data even after the computer 500 is turned off and when the power is not supplied. The ROM 505 stores the programs and/or data such as a basic input output system (BIOS), which is executed when the computer 500 starts up, OS settings, and network settings. The RAM 504 is an example of a volatile semiconductor memory (storage device), temporarily stores programs and/or data.

The CPU 506 reads programs and/or data from a storage device such as the ROM 505 and the HDD 508 onto the RAM 504, and executes the programs to control the overall operation of the computer 500 and implement functions of the computer 500.

With the hardware configuration of the computer 500 as illustrated in FIG. 3, each of the job execution service apparatus 10, the log storage device 12, and the content provision service apparatus 14 implements various types of operation as described later. Additionally, with the hardware configuration of the computer 500 as illustrated in FIG. 3, each of the one or more information processing apparatuses configuring the external storage system 40 and the terminal device 30 implements various types of operation as described later.

### <<MFP>>

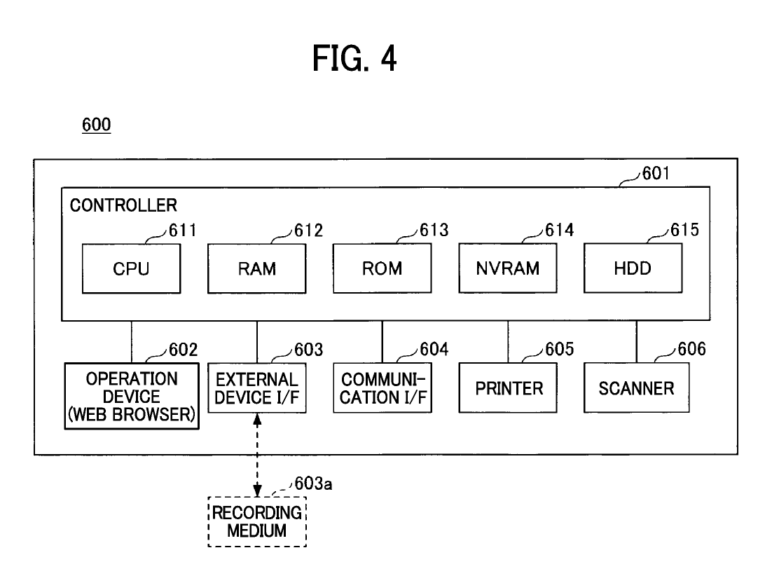

The MFP 600, which is one example of the apparatus 20 of FIG. 1 has a hardware configuration illustrated in FIG. 4, for example. FIG. 4 is a diagram illustrating a hardware configuration of the MFP 600. As illustrated in FIG. 4, the MFP 600 includes a controller 601, an operation device 602, an external device interface (I/F) 603, a communication interface (I/F) 604, a printer 605, and a scanner 606.

The controller 601 includes a CPU 611, a RAM 612, a ROM 613, a non-volatile random access memory (NVRAM) 614, and an HDD 615. The ROM 613 stores various programs and data. The RAM 612 temporarily stores programs and data. The NVRAM 614 stores setting information, etc., for example. The HDD 615 stores various programs and data.

The CPU 611 performs processing according to the programs, the data, the setting information, etc., read from the ROM 613, the NVRAM 614, the HDD 615, etc., onto the RAM 612 to control the overall operation of the MFP 600 and implement functions of the MFP 600.

The operation device 602 includes an input unit that receives a user input, and a display unit that displays various types of information. The operation device 602 is installed with a web browser. In one or more embodiments, the operation device 602 is implemented with an information processing terminal.

The external device interface 603 is an interface device that connects the MFP 600 to an external device. Examples of the external device include a recording medium 603a. The external device interface 603 enables the MFP 600 to read and write data from and to the recording medium 603a. Examples of the recording medium 603a include an integrated circuit (IC) card, a flexible disc, a CD, a DVD, a SD memory card, a USB memory, etc.

The communication interface 604 is an interface device to connect the MFP 600 to the network N2. The MFP 600 performs data communication via the communication interface 604. The printer 605 is a printing device that forms an image on a transfer medium based on print data. Examples of the transfer medium include a sheet of paper, coated paper, thick paper, overhead projector (OHP) transparency, plastic film, pre-preg, and copper foil. The scanner 606 is a reading device that scans a document to obtain image data (electronic data).

The MFP 600 according to the present embodiment implements various types of processing as described later with the hardware configuration as described above.

### <Software Configuration>

Each of the job execution service apparatus 10 and the operation device 602 of the apparatus 20 in the information processing system 1 according to the present embodiment implements processing blocks (functional blocks) described below. The processing blocks of the job printing and the processing brocks of the storage printing are described individually in the following description. For simplicity, a description of the processing brocks that are unnecessary for explanation of the embodiment is omitted below.

### <<Job Printing>>

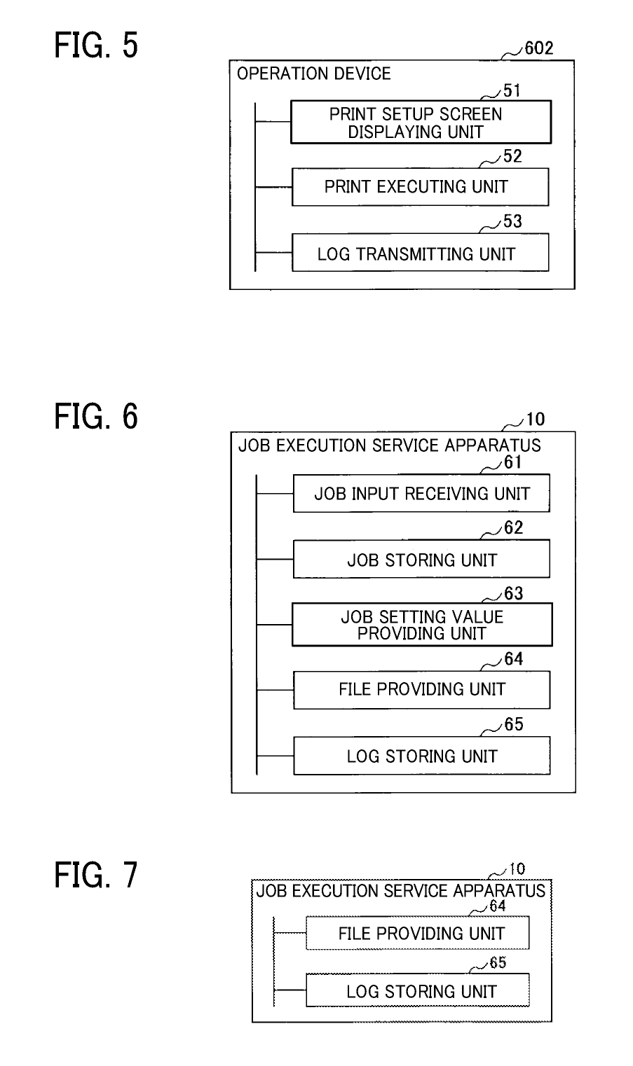

FIG. 5 is a block diagram illustrating a functional configuration of the operation device 602 in the job printing according to the present embodiment. The operation device 602 includes a print setup screen displaying unit 51, a print executing unit 52, and a log transmitting unit 53. The operation device 602 of FIG. 5 is installed with the web browser. Each of the print setup screen displaying unit 51 and the print executing unit 52, and the log transmitting unit 53 is implemented by executing the content provided from the content provision service apparatus 14 with the web browser.

The print setup screen displaying unit 51 displays a print setup screen, which is described later. The print executing unit 52 receives a print execution request input from the print setup screen by the user and executes the print job. The log transmitting unit 53 transmits a log of the executed print job to the job execution service apparatus 10.

FIG. 6 is a block diagram illustrating a functional configuration of the job execution service apparatus 10 in the job printing according to the present embodiment. The job execution service apparatus 10 includes a job input receiving unit 61, a job storage unit 62, a job setting value providing unit 63, a file providing unit 64, and a log storing unit 65. Each of the job input receiving unit 61, the job storage unit 62, the job setting value providing unit 63, the file providing unit 64, and the log storing unit 65 illustrated in FIG. 6 is implemented by executing a program in the job execution service apparatus 10.

The job input receiving unit 61 receives an input of a print job from the terminal device 30. The job storage unit 62 stores the print job. The job setting value providing unit 63 provides a set of setting values of the job input (a set of job setting values of job input) to the operation device 602. The file providing unit 64 provides the print job to the apparatus 20. The log storing unit 65 stores a log of the executed print job in the log storage device 12.

### <<Storage Printing>>

The processing blocks in the operation device 602 in the storage printing is substantially the same as the processing blocks illustrated in FIG. 5, and the description of the processing blocks in the storage printing is omitted. FIG. 7 is a block diagram illustrating a functional configuration of the job execution service apparatus 10 in the storage printing according to the present embodiment. The job execution service apparatus 10 includes the file providing unit 64 and the log storing unit 65. Each of the file providing unit 64 and the log storing unit 65 illustrated in FIG. 7 is implemented by executing a program in the job execution service apparatus 10.

The file providing unit 64 provides a file that is downloaded from the external storage system 40 to the apparatus 20. The log storing unit 65 stores a log of an executed print job in the log storage device 12. The functional configuration of the job execution service apparatus 10 of FIG. 7 has a configuration of which the processing blocks related to the job input are excluded from the functional configuration of FIG. 6.

### <Operation>

A detailed description is given of the information processing system 1 according to the first embodiment below.

### <<Log Acquisition in Job Printing>>

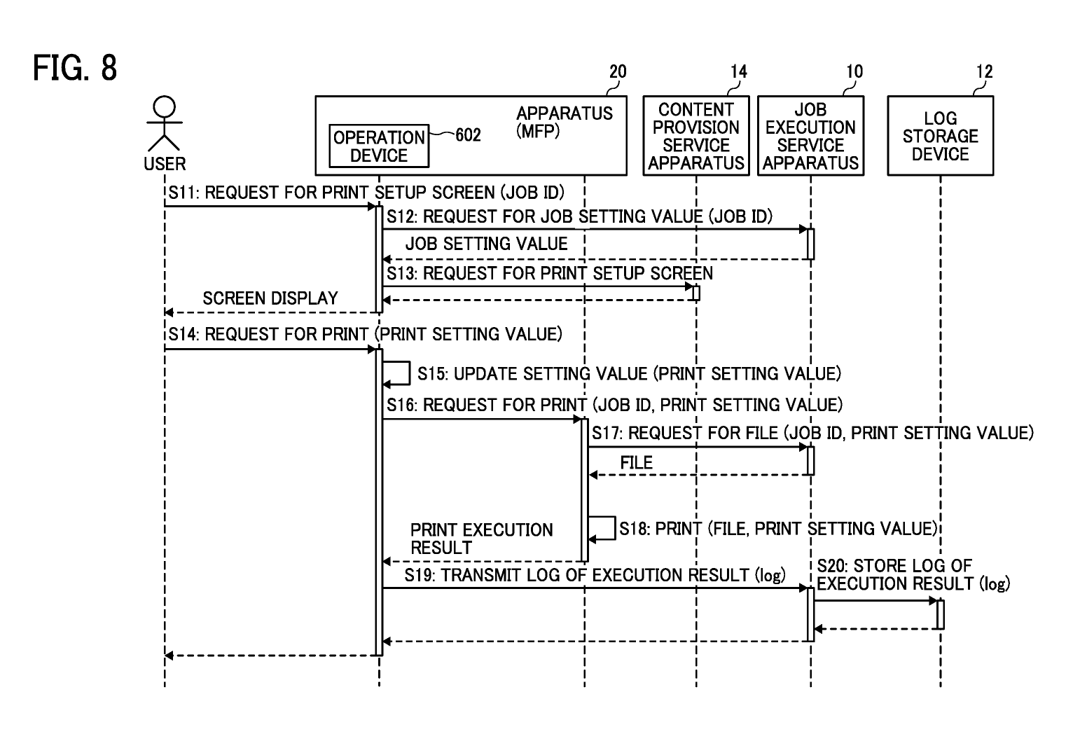

FIG. 8 is a sequence diagram illustrating a log acquisition process in the job printing. In FIG. 8, the process of the sequence diagram, which is for executing a print job, starts after a print job is input.

The user selects the input print job and requests for a setup screen with the operation device 602 in S11. The print setup screen displaying unit 51 of the operation device 602 specifies a jog identification (ID) of the print job selected by the user, and requests the job execution service apparatus 10 for a set of job setting values in S12. The job setting value providing unit 63 of the job execution service apparatus 10 provides the control device 602 with the set of job setting values for the print job identified with the job ID.

In S13, the print setup screen displaying unit 51 of the operation device 602 requests the content provision service apparatus 14 for Hyper Text Markup Language (HTML) data, which is one example of the content, for the print setup screen. The content provision service apparatus 14 provides the HTML data for the print setup screen to the operation device 602 of the apparatus 20.

The print setup screen displaying unit 51 of the operation device 602 displays the print setup screen with the HTML data provided from the content provision service apparatus 14. In S14, the user requests to execute printing for the print job from the print setup screen. At this time, the user may change, from the print setup screen, a part or all of the print setting values set when the job is input. The user may change the setting values, for example, for the number of copies, a duplex/simplex setting, and a full color/monochrome setting.

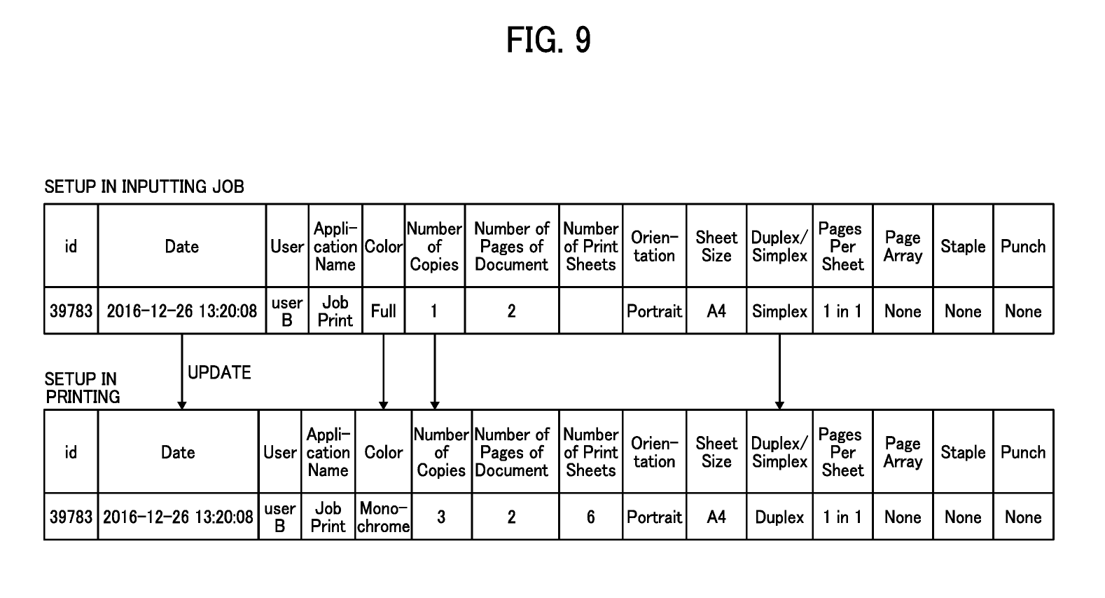

In S15, the print executing unit 52 of the operation device 602 updates the print setting values from the print setting values of job input to the print setting values of print job set in S14, as illustrated in FIG. 9. FIG. 9 is an illustration of update of the print setting values. An upper table in FIG. 9 illustrates the settings values of job input. A lower table in FIG. 9 illustrates the setting values of at the time of printing (setting value of print job).

The table of settings illustrated in FIG. 9 includes items of id, date, application name, color, number of copies, number of pages of a document, number of print sheets, orientation, sheet size, duplex/simplex, pages per sheet, page array, staple and punch, and each item has a print setting value. In the example of FIG. 9, the print setting values for the items of date, color, number of copies, and duplex/simplex are updated.

In S16, the print executing unit 52 of the operation device 602 specifies the job ID and the print setting values and requests the controller 601 to execute the printing. In one or more embodiments, the job ID includes a path to the file (job execution uniform resource locator (URL)). For example, the job execution URL includes an application name and the job ID (or a file ID in a case of the storage printing). The apparatus 20 requests the job execution service apparatus 10 for a file by specifying the job ID and the print setting values (the set of the print setting values) for the print job and obtains the file corresponding to the job ID in S17. The controller 601 of the apparatus 20 causes the printer 605 to print based on the file and the print setting values in S18. The controller 601 notifies the operation device 602 of a result of the printing, or the controller 601 transmits a notification of the print job execution result.

The log transmitting unit 53 of the operation device 602, which receives the notification of the print job execution result, transmits a log of the print job execution result to the job execution service apparatus 10. The log storing unit 65 of the job execution service apparatus 10 stores the log of the print job execution result in the log storage device 12 in S20. For example, the log storing unit 65 stores a value of the number of print sheets that is obtained by multiplying the number of copies by the number of pages of the document.

In the sequence diagram illustrated in FIG. 8, the operation device 602 directly transmits the log of the print job execution result to the job execution service apparatus 10, however the embodiments are not limited to this. In one or more embodiments, the content provision service apparatus 14 relays the log of the print job execution result.

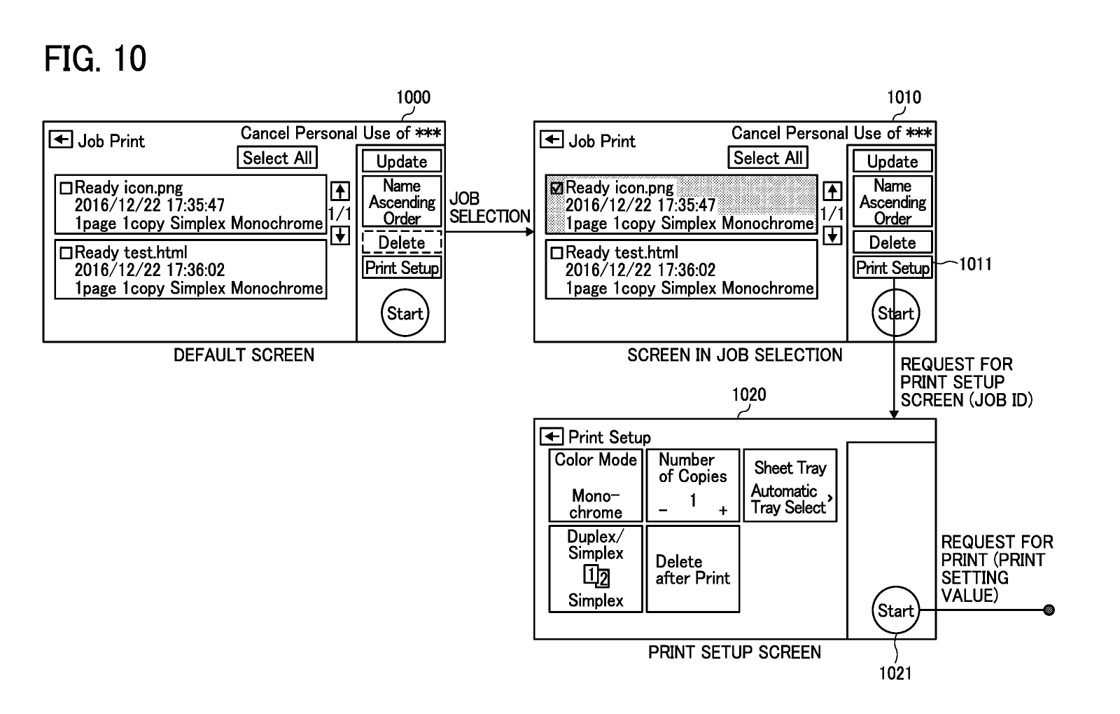

FIG. 10 is an illustration of an example of screen transition in the log acquisition process in the job printing. The screen transition illustrated in FIG. 10 illustrates a screen displayed by the operation device 602 of the apparatus 20. A default screen 1000 displays a print job input by the user in a manner that the print job is selectable. A default screen 1010 displays a state where the print job is selected by the user. When a print setting button 1011 is pressed on the default screen 1010, the operation device 602 of the apparatus 20 transitions the default screen 1010 to a print setting screen 1020.

The print setting screen 1020 is used by the user to update the print setting value set at the time of the job input. By pressing a “Start” button 1021 on the print setting screen 1020, the user requests to execute the printing in S14.

### <<Log Acquisition in Storage Printing>>

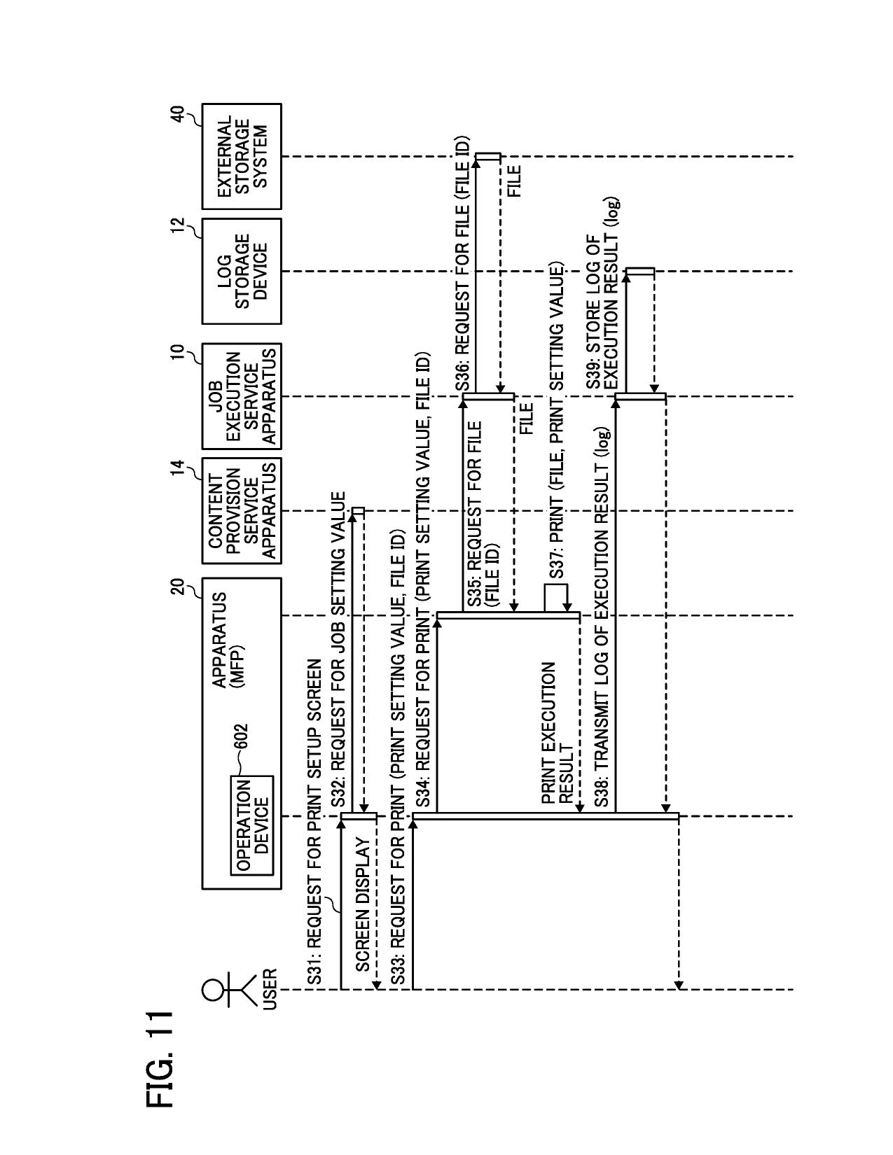

FIG. 11 is a sequence diagram illustrating a log acquisition process in the storage printing. The user uses the operation device 602 to request to display the print setup screen in S31. In S32, the print setup screen displaying unit 51 of the operation device 602 requests the content provision service apparatus 14 for HTML data for the print setup screen.

The content provision service apparatus 14 provides the HTML data for the print setup screen to the operation device 602 of the apparatus 20. The print setup screen displaying unit 51 of the operation device 602 displays the print setup screen with the HTML data provided from the content provision service apparatus 14.

In S33, the user requests to execute printing by specifying a file and print setting values from the print setup screen. In S34, the print executing unit 52 of the operation device 602 specifies the print setting values and a file ID, and requests the controller 601 to execute the printing. The apparatus 20 requests the job execution service apparatus 10 for the file by specifying the file ID in S35.

In S36, the file providing unit 64 of the job execution service apparatus 10 acquires the file by specifying the file ID from the external storage system 40, and transmits the file to the apparatus 20. The controller 60 of the apparatus 20 causes the printer 605 to print based on the file and the print setting values in S37. The controller 601 notifies the operation device 602 of a result of the printing, or transmitting to the operation device 602 a notification of a print job execution result.

The log transmitting unit 53 of the operation device 602, which receives the notification of the print job execution result, transmits a log of the print job execution result to the job execution service apparatus 10 in S38. The log storing unit 65 of the job execution service apparatus 10 stores the log of the print job execution result in the log storage device 12 in S39. For example, the number of print sheets is stored as a log in the log storage device 12.

In the sequence diagram illustrated in FIG. 11, the operation device 602 directly transmits the log of the print job execution result to the job execution service apparatus 10, however the embodiments are not limited to this. In one or more embodiments, the content provision service apparatus 14 relays the log of the print job execution result.

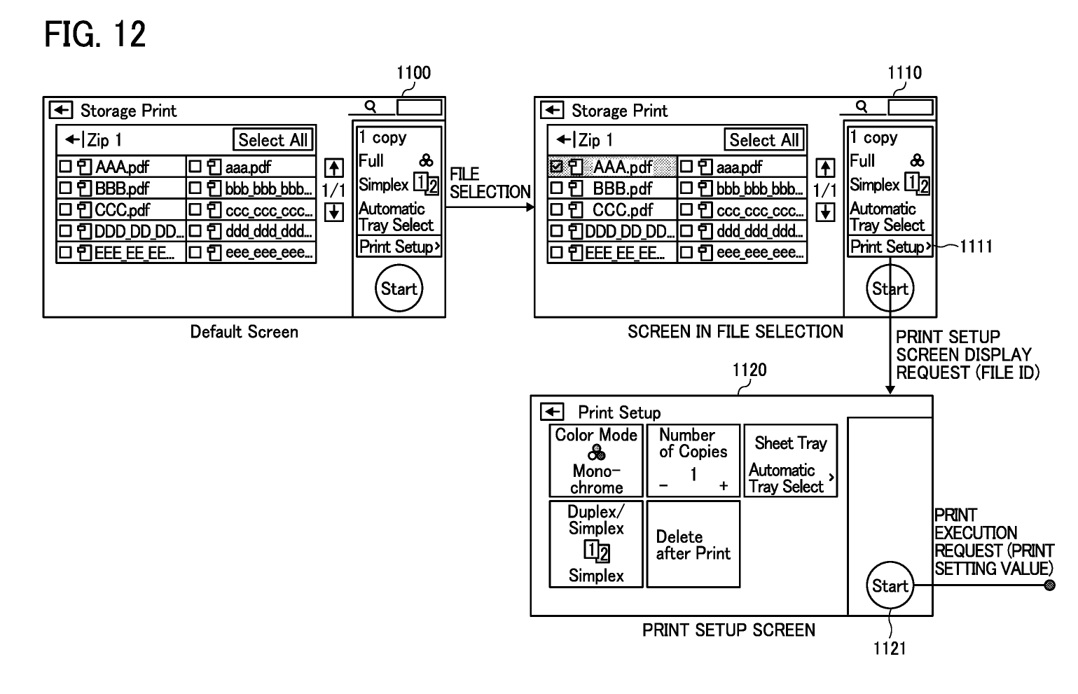

FIG. 12 is an illustration of an example of screen transition in the log acquisition process in the storage printing. The screen transition illustrated in FIG. 12 illustrates screens displayed by the operation device 602 of the apparatus 20. A default screen 1100 displays the file saved by the user in a manner that the file is selectable. A default screen 1110 displays a state where the file is selected by the user. When a print setting button 1111 is pressed on the default screen 1110, the operation device 602 of the apparatus 20 transitions the default screen 1110 to a print setting screen 1120.

The print setting screen 1120 is used by the user to set the print setting values. By pressing a “Start” button 1121 on the print setting screen 1120, the user requests to execute the printing in S33.

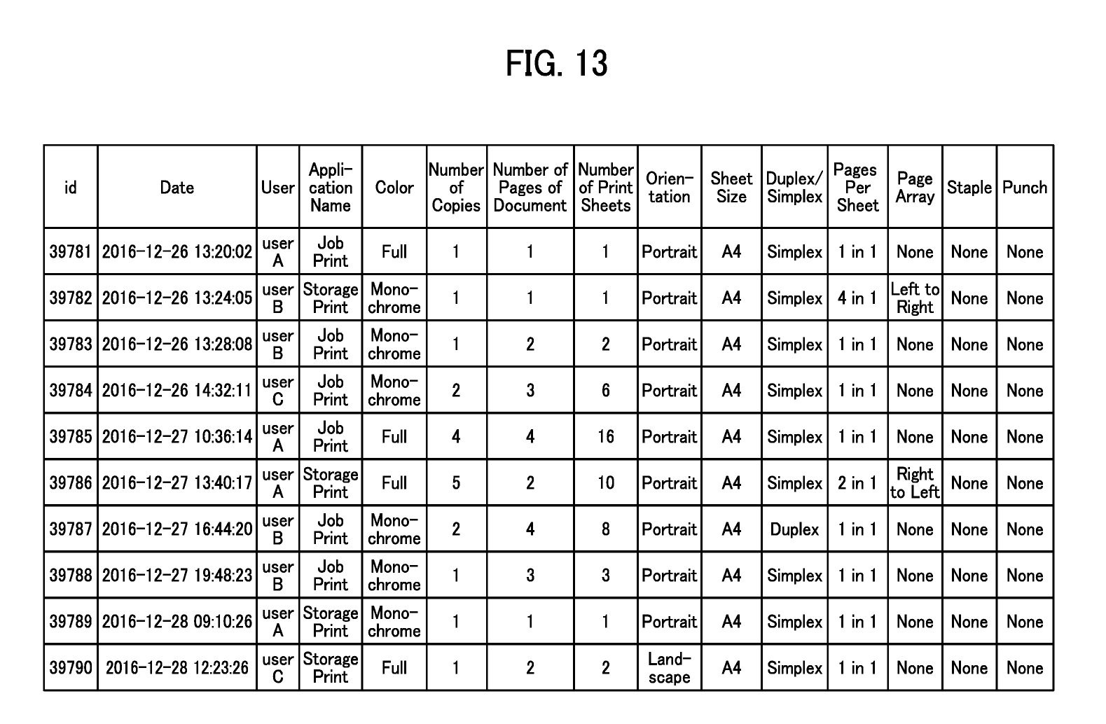

FIG. 13 is an example of a configuration of logs of the print jobs stored in the log storage device 12. In the example of FIG. 13, the log is rewriteable from the setting values of job input (set at a time of inputting a job) to the print setting values of print job (set at a time of printing a job), however, the embodiments are not limited to this. In one or more embodiments, there are a column for the setting values of job input (set at a time of inputting a job) and another column for the setting values of print job (set at a time of printing a job).

As described above, according to the present embodiment, the job execution service apparatus 10 that coordinates the apparatus 20 with the service to provide a device coordination service acquires the log of the job executed in the apparatus 20. Accordingly, the job execution service apparatus 10 in the service provision environment E1 is able to provide a charging service using the logs.

### Second Embodiment

In a second embodiment, the job execution service apparatus 10 coordinates the apparatus 20 with the service uses the log of the job to limit the number of print sheets. A description of elements, members, components, or operations that are the same as those in the first embodiment is omitted below.

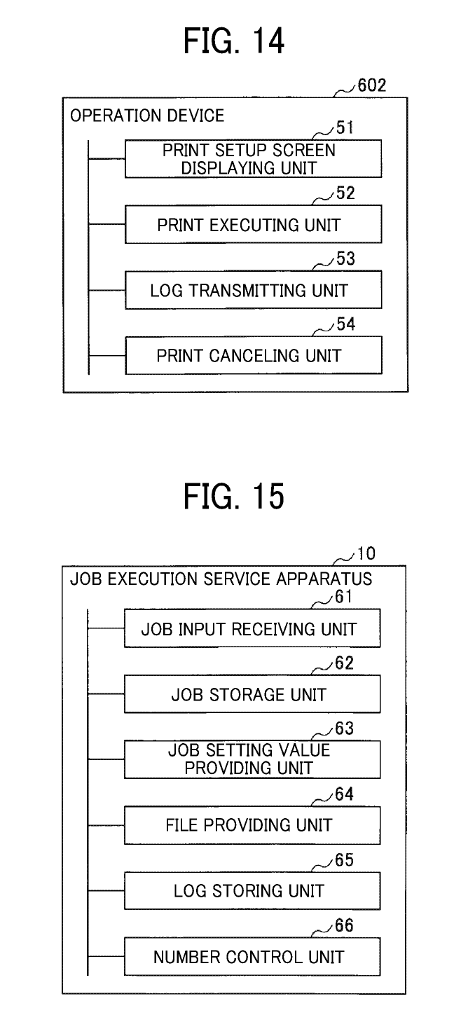

FIG. 14 is a block diagram illustrating a functional configuration of the operation device 602 according to the present embodiment. The operation device 602 includes the print setup screen displaying unit 51, the print executing unit 52, the log transmitting unit 53, and a print cancelling unit 54. The configuration of the operation device 602 of FIG. 14 is equal to a configuration including the same elements of configuration of 602 of FIG. 5 and the print cancelling unit 54. The print cancelling unit 54 stops printing when the number of print sheets exceeds a limitation (limited number), which may be set by, for example, a system administrator, in the job execution service apparatus 10.

FIG. 15 is a block diagram illustrating a functional configuration of the job execution service apparatus 10 according to the present embodiment. The job execution service apparatus 10 includes the job input receiving unit 61, the job storage unit 62, the job setting value providing unit 63, the file providing unit 64, the log storing unit 65, and a number control unit 66. The configuration of the job execution service apparatus 10 of FIG. 15 is substantially the same as a configuration including the same elements of the configuration of FIG. 6 and the number control unit 66. The number control unit 66 obtains the number of print sheets (the number of printed sheets) from the log of the print job saved in the log storage device 12, and notifies the operation device 602 of an error when the number of print sheets exceeds the limitation. The configuration of FIG. 15 illustrates in a case of the job printing.

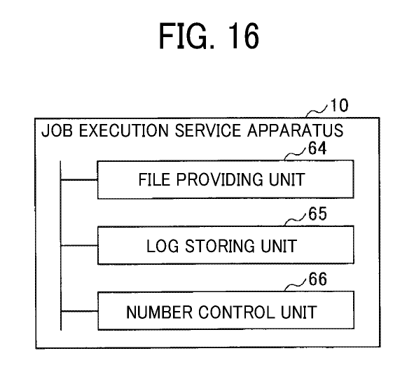

FIG. 16 is a diagram illustrating a functional configuration of the job execution service apparatus 10 in a case of the storage printing, according to the present embodiment. The job execution service apparatus 10 includes the file providing unit 64, the log storing unit 65, and the number control unit 66. The configuration of the job execution service apparatus 10 of FIG. 16 is substantially the same as a configuration including the same elements of the configuration of FIG. 7 and the number control unit 66.

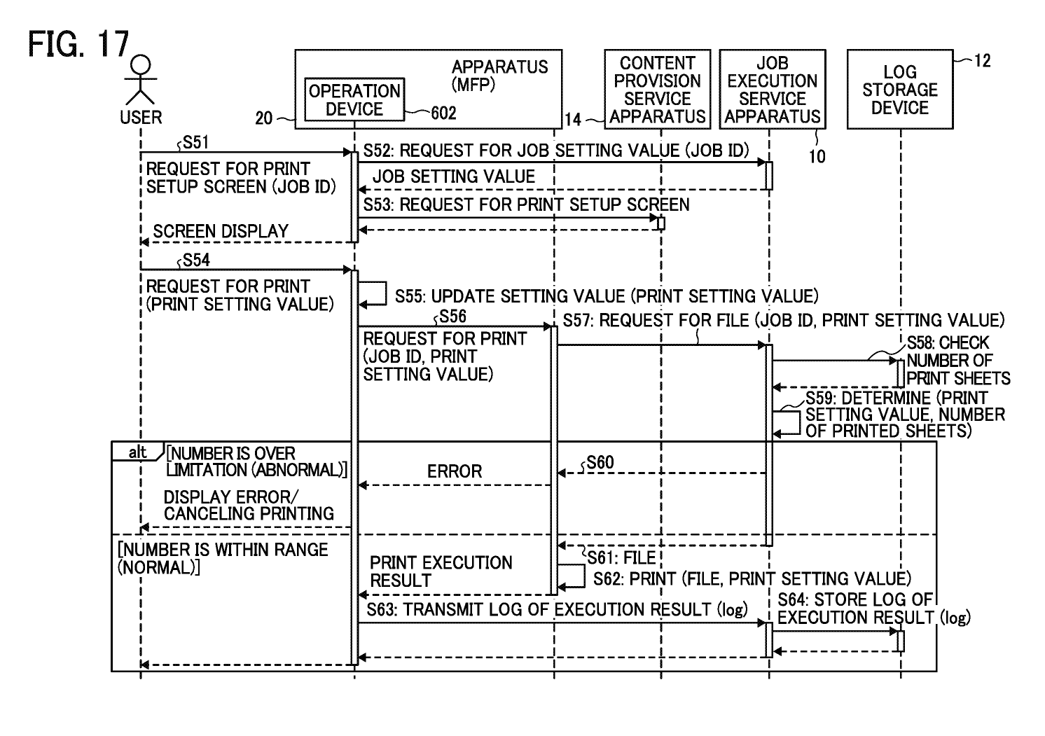

FIG. 17 is a sequence diagram illustrating a log acquisition process in the job printing. The processing from the S51 to S57 in FIG. 17 is substantially the same as the processing from S11 to S17 of the sequence diagram illustrated in FIG. 8.

In S57, the number control unit 66 of the job execution service apparatus 10 receives, from the apparatus 20, a request for a file specified with the job ID and the print setting values. The number control unit 66, subsequently, obtains the number of print sheets (printed sheet) from the log of the print job saved in the log storage device 12 in S58.

In S59, the number control unit 66 calculates the number of print sheets that is to be used for the following printing (additional number of sheets) based on the request for the file received in S57, and determines whether the number of print sheets including the additional number of sheets, which is to be used for the following printing, exceeds the limitation based on the additional number of sheets.

When determining that the number of print sheets exceeds the limitation, the number control unit 66 notifies the operation device 602 of an error in S60. In response to the error, the print cancelling unit 54 of the operation device 602 cancels, or stops the printing.

On the other hand, when determining that the number of print sheets is equal to or less than the limitation, the number control unit 66 notifies the file providing unit 64 of that the number of print sheets is equal to or less than the limitation. In S61, the file providing unit 64 transmits to the apparatus 20 a file corresponding to the file request received in S57. Processing after S62 is substantially the same as the processing after S18 of the sequence diagram illustrated in FIG. 8, and the description of the processing after S62 is omitted.

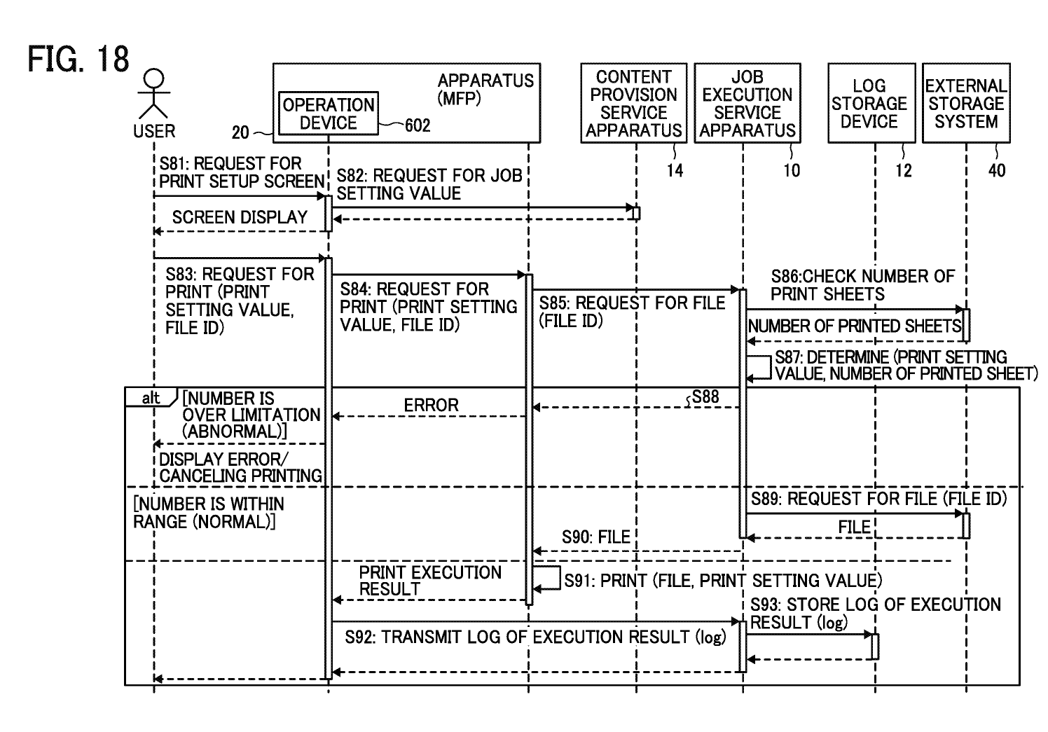

FIG. 18 is a sequence diagram illustrating a log acquisition process in the storage printing. The processing from S81 to S83 in FIG. 18 is substantially the same as the processing from S31 to S33 of the sequence diagram illustrated in FIG. 11.

In S84, the print executing unit 52 of the operation device 602 specifies the print setting values and a file ID, and requests the controller 601 to execute the printing. The apparatus 20 requests the job execution service apparatus 10 for the file by specifying the file ID and the print setting value in S85. When receiving the request for the file specified with the file ID and the print setting values, the number control unit 66 of the job execution service apparatus 10 obtains the number of print sheets (printed sheet) from the log of the print job saved in the log storage device 12 in S86.

In S87, the number control unit 66 calculates the number of print sheets that is to be used for the following printing (additional number of sheets) based on the request for file received in S85, and determines whether the number of print sheets including the additional number of sheets, which is to be used for the following printing, exceeds the limitation.

When determining that the number of print sheets exceeds the limitation, the number control unit 66 notifies the operation device 602 of an error in S88. In response to the error, the print cancelling unit 54 of the operation device 602 cancels, or stops, the printing.

On the other hand, when determining that the number of print sheets is equal to or less than the limitation, the number control unit 66 notifies the file providing unit 64 of that the number of print sheets is equal to or less than the limitation in S89. Processing after S89 is substantially the same as the processing after S36 of the sequence diagram illustrated in FIG. 11, and the description of the processing after S89 is omitted.

As described above, according to the second embodiment, the job execution service apparatus 10 that coordinates the apparatus 20 with the service uses the log of the job to limit the number of print sheets. The job execution service apparatus 10 in the service provision environment E1, accordingly, to stop the printing when the number of print sheets exceeds the limitation by using the logs.

### VARIATIONS

In the description above referring to the first and second embodiments, printing is performed, however, the embodiments of the disclosure are not limited to these and any other functions using content executable on the control device 602 of the apparatus 20 may be used. For example, scanning may be performed with the content executable on the control device 602 of the apparatus 20. Additionally, in the second embodiment, the example of limiting the number of print sheet is described, however the embodiments of the disclosure are not limited to this and any other matters that are able to be limited by the job execution service apparatus 10 using the log of the job may be applied.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. The apparatus 20 is one of the example of an apparatus installed with a web browser. The one or more information processing apparatuses implementing the service provision environment E 1 is examples of one or more information processing apparatuses connected to the apparatus via a network.

It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing system, comprising:
an apparatus installed with a web browser; and
one or more information processing apparatuses connected to the apparatus through a network, the one or more information processing apparatuses including:
first circuitry to provide the apparatus with a content executable on the web browser, the content being embedded with an instruction to transmit a log of processing performed according to a user request; and
second circuitry to provide a device coordination service that coordinates the apparatus in which the content is executed with the web browser with a service to be provided through the network, receive, from the apparatus in which the content is executed, a log of processing performed with the apparatus, the processing being performed according to a user request, and store the log transmitted from the apparatus in a memory.

2. The information processing system of claim 1,
wherein the second circuitry is further configured to:
determine whether to execute processing of the user request based on the log stored in the memory; and
transmit a determination result to the apparatus in which the content is executed on the web browser, and
wherein the apparatus in which the content is executed on the web browser selectively performs executing the processing of the user request and canceling of the processing of the user request according to the determination result.

3. The information processing system of claim 1, wherein the second circuitry
determines whether to execute printing of the user request based on the number of printed sheets stored as the log in the memory, the number of additional print sheets that is to be added to the log upon execution of the printing of the user request, and a limited number indicating limitation on the printable number,
wherein, when a sum of the number of printed sheets and the number of additional print sheets exceeds the limited number, the circuitry
transmits a determination result indicating to cancel the execution of the printing of the user request to the apparatus in which the content is executed on the web browser, and
when the sum of the number of printed sheets and the number of additional print sheets is equal to or less than the limited number, the circuitry
transmits a determination result indicating to perform the execution of the printing of the user request to the apparatus in which the content is executed on the web browser.

4. The information processing system of claim 3, wherein the second circuitry is further configured to:
receive a job input from a terminal connected through the network according to a user operation;
store the job input from the terminal;
receive a request for the job from the apparatus in which the content is executed on web browser; and
provide the apparatus with the job in response to the request for the job from the apparatus.

5. The information processing system of claim 4, wherein the apparatus in which the content is executed on the web browser updates a setting value set at a time when the job is input to a setting value set at a time when a user request to print the job is received.

6. The information processing system of claim 1, wherein the second circuitry receives from the apparatus a request for a file that is stored in an external service, and acquires from the external service the file to be provide to the apparatus.

7. A method for storing a job log, comprising:
providing an apparatus with a content executable on the web browser;
provide a device coordination service that coordinates the apparatus in which the content with the web browser with a service to be provided through a network;
receiving, from the apparatus in which the content is executed, a log of processing performed according to a user request with the apparatus; and
storing in a memory the log transmitted from the apparatus.

8. An information processing apparatus communicably connected to an apparatus installed with a web browser through a network, the information processing apparatus comprising:
first circuitry configured to provide apparatus with a content executable on the web browser, the content being embedded with an instruction to transmit a log of processing performed according to a user request; and
second circuitry to second circuitry to provide a device coordination service that coordinates the apparatus in which the content with the web browser with a service to be provided through a network, receive, from the apparatus in which the content is executed, a log of processing performed according to a user request with the apparatus, and store the log transmitted from the apparatus in a memory.
